(19) United States
(12) Patent Application Publication
(10) Pub. No.: US 2025/0128581 A1
(43) Pub. Date: Apr. 24, 2025

(54) VARIABLE POSITION WINDBREAK FOR SUNROOF EQUIPPED VEHICLES

(71) Applicant: FCA US LLC, Auburn Hills, MI (US)

(72) Inventors: Richard S. Silbert, Bingham Farms, MI (US); Jason L. Vincent, Howell, MI (US); Patrick D. Reed, Washington, MI (US)

(21) Appl. No.: 18/491,211

(22) Filed: Oct. 20, 2023

(51) Int. Cl. B60J 7/057; B60J 7/043

(52) U.S. Cl. CPC B60J 7/0573; B60J 7/043; B60Y 2306/09

(57) ABSTRACT

A method and system for controlling a windbreak for a vehicle includes determining a sound signal corresponding to a sound level within the vehicle a minimizing the sound level within the vehicle by moving the windbreak.

### FIELD

The present disclosure relates to a sunroof equipped vehicles and, more particularly, to positioning a windbreak to reduce the noise in a sunroof equipped vehicle.

### BACKGROUND

This section provides background information related to the present disclosure which is not necessarily prior art.

Sunroofs or moon roofs are examples of movable panels that are used on the roof of the vehicle to open the roof of the vehicle. While driving with an open roof panel, the wind noise created across the opening is heard within the vehicle and is undesirable. When the vehicle is driving, a windbreak is deployed to reduce the wind noise within the vehicle. Typically, windbreaks are a plastic and/or plastic and fabric member that extends above and across the front edge of the opening above the plane of the roof. Typically, the windbreak is spring loaded to move upward when the panel is opened and retracts as the roof panel is closed. The windbreak changes the airflow over the opening and thus reduces the noise within the vehicle. Often times, the windbreak is positioned in a single position and therefore wind noise is not reduced during different driving conditions.

### SUMMARY

This section provides a general summary of the disclosure and is not a comprehensive disclosure of its full scope or all of its features.

In the present disclosure, the windbreak may be positioned by a motor dependent on the noise level or sound level within the vehicle. Therefore, the windbreak is variably positioned during vehicle operation.

In one aspect of the disclosure, a method for controlling a windbreak for a vehicle includes determining a sound signal corresponding to a sound level within the vehicle a minimizing the sound level within the vehicle by moving the windbreak.

In another aspect of the disclosure, a system for controlling a windbreak for a vehicle includes a sound sensor and a controller programmed to determine a sound signal corresponding to a sound level within the vehicle and minimize the sound level within the vehicle by moving the windbreak.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a portion of the vehicle having a movable roof panel.

FIG. 2 is a block diagrammatic view of the adjustable windbreak system in a vehicle.

FIG. 3 is a flowchart of a first method for adjusting the windbreak.

FIG. 4 is a second method for adjusting the windbreak.

FIG. 5 is a flowchart of the method for minimizing the sound level in step 410.

Corresponding reference numerals indicate corresponding parts throughout the several views of the drawings.

### DETAILED DESCRIPTION

Example embodiments will now be described more fully with reference to the accompanying drawings.

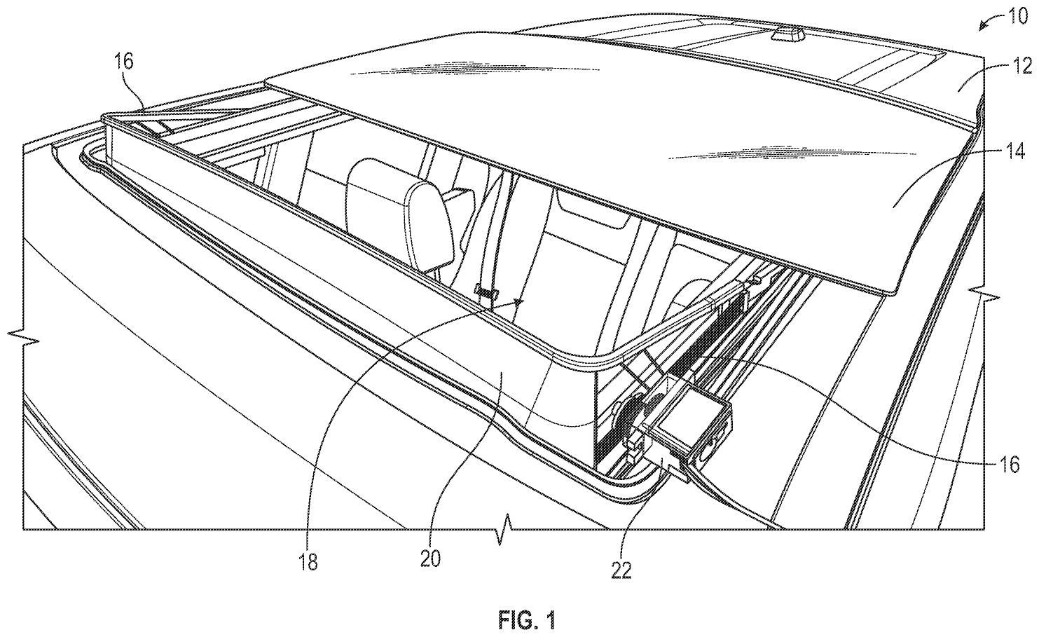

Referring now to FIG. 1, a vehicle 10 has a roof 12 that has a movable panel 14 as set forth therein. The movable panel 14 is formed of glass, metal, composite material or combinations thereof. In this example, the panel 14 is received under a plane of the roof 12 in an open position. However, other examples allow the panel 14 to be positioned above the roof 12 during operation. The panel 14 moves within a pair of rails 16 on each side of the vehicle. The rails 16 are disposed longitudinally relative to the vehicle 10. An opening 18 in the roof 12 is formed when the panel 14 is retracted.

A windbreak 20 is shown in a first position after the panel 14 is opened. The windbreak 20 extends laterally across and is adjacent to and in front of (relative to the forward motion of the vehicle 10) the opening 18. The windbreak 20 is coupled to a motor 22 so that the windbreak 20 is variably positioned upward and downward during the operation of the vehicle 10 to change noise generated at the opening 18 as described in further detail below. In the position illustrated, the windbreak 20 is above the plane of the roof 12.

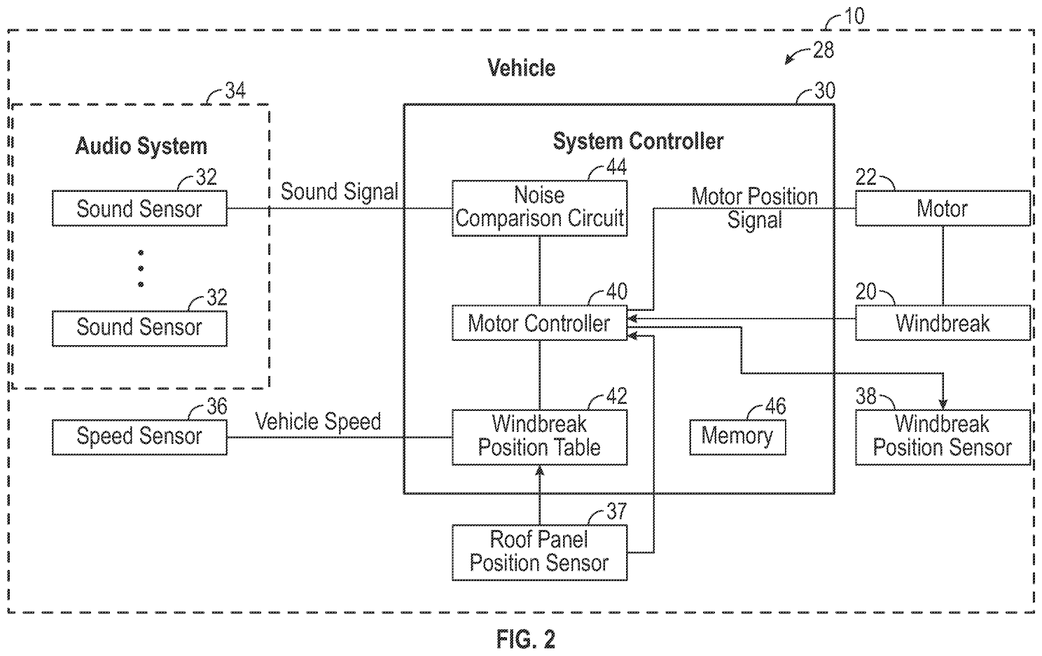

Referring now to FIG. 2, a system 28 for controlling the windbreak 20 of the vehicle 10 has a system controller 30 in communication with one or more sound sensors 32. The sound sensors 32 are illustrated as part of an audio system 34. This advantageously reduces the cost of implementation. However, the sound sensors 32, in other examples, are standalone sensors. The sound sensors 32, for example, are a piezoelectric device such as a microphone that generates an electrical signal corresponding to the audible sound level within the vehicle 10. The sound sensors 32 are be positioned in various positions throughout the vehicle including at various seating positions such as the front driver side, the front passenger side, a position in between the front passenger side and the front driver side and within the rear of the vehicle 10.

The controller 30 is also coupled to a speed sensor 36 that generates a speed signal that corresponds to the speed of the vehicle. Sensors for obtaining the vehicle speed are well-known.

The controller 30 in some examples is coupled to a roof panel position sensor 37 that generates a roof position signal that corresponds to a position of the roof panel 14 relative to the opening 18. That is, the amount of opening may be determined by the roof panel position sensor 37.

The controller 30 is also coupled to the motor 22. The motor 22, by way of example, is a servo motor 22 or another type of motor such as a stepper motor. The motor 22, as mentioned above, is coupled to the windbreak 20.

The controller 30 has various circuits or modules that are part of the controller 30 for controlling various aspects of the disclosure. The controller 30 may be microprocessor-based and is programmed to perform the various functions. In one example, the circuits or modules are separate integrated circuits. In other examples, the controller 30 is programmed in software to perform various functions.

The controller 30 has a motor controller 40. The motor controller 40 generates a motor signal to position the motor 22 into a desired position. The motor controller and the motor position signal may move the motor 22 in a forward and reverse direction to allow the windbreak 20 to be moved into the desired position.

The motor controller 40 is in communication with a windbreak position table 42 within the controller 30. The windbreak position table 42 is an optional feature that generates a desired position for the windbreak 20 based upon the speed of the vehicle, the position of the panel or both. The windbreak position table 42 therefore provides an initial position for the windbreak 20 to the motor controller 40. A calibrated position sound level for each vehicle speed, panel position or both may be stored in the table. The windbreak position table 42 is calibrated during vehicle development. Other influences such as the wind around the vehicle change the noise generated and therefore adjustments from the system 28 are made based on the sound level in the vehicle 10.

A noise comparison circuit 44 is in communication with the sound sensors 32 and receives the electrical sound signal from the sound sensors 32. The noise comparison circuit 44 compares the sound signal to a sound threshold. If more than one sound sensor is used, the sound sensor with the highest sound level is used in the determination. When the sound corresponding to the sound signal is greater than the sound threshold, the noise comparison circuit 44 communicates with the motor controller to allow the motor controller 40 to position the motor 22 and therefore the windbreak 20.

A memory 46 is also associated with the controller 30. The memory 46 may store the windbreak position table 42 therein and also positions of the motor 22 during the operation as will be described in greater detail below.

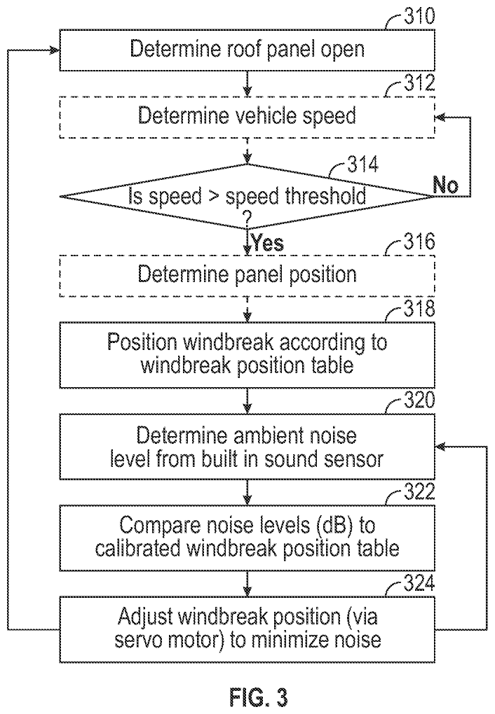

Referring now to FIG. 3, one method for operating the windbreak is set forth. The system and method operate when the roof panel is opened. Therefore, step 310 determines whether the roof panel is opened. In step 312, the vehicle speed is determined. The vehicle speed may be used as an optional step to prevent the system from operating under a predetermined speed because little or no noise is generated by the open roof panel at low speeds. For example, when the vehicle speed is greater than a speed threshold such as 10 mph in step 314, the system may operate and proceed to step 316. When the vehicle speed is not greater than the vehicle speed threshold in step 314, step 312 is again performed. After step 314 when the speed is greater than a speed threshold, control moves to step 316. Step 316 is an optional step that determines the panel position. In step 318 the position of the windbreak is set to a position based on the vehicle speed, the panel position or both from the windbreak position table 42. In step 320 the sound level sensors determine the ambient noise level from the built-in sound sensors within the vehicle. As mentioned above, the sound sensors 32 may be incorporated into the audio system 34 or positioned within the vehicle 10 for the purpose of determining the sound of the wind noise from the opening 18 of the roof panel 14.

In step 322, the noise level determined by the sound sensor is compared to the calibrated windbreak position table. The windbreak position table 42 was mentioned above in FIG. 2. The windbreak position table 42 may be a windbreak position that varies based upon the vehicle speed or the sunroof position or both as mentioned above. Vehicle testing and calibration may determine the desired sunroof position at various speed thresholds and a sound level associated therewith. After step 322, the windbreak position may be adjusted in step 324 to minimize the noise. Minimizing the noise may provide a “seeking” function. That is, the windbreak 20 may be positioned by moving the motor in a forward or rearward position to seek the lowest amount of noise determined from the sound sensors. Therefore, steps 316 and 320 may be continually operated when the roof panel is opened, and the vehicle speed is above the threshold in steps 310 and 314.

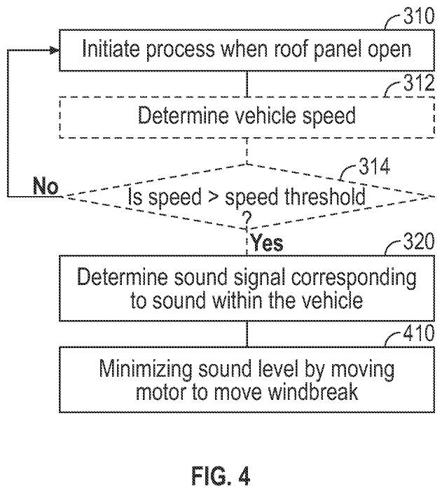

Referring now FIG. 4, an alternative method is set forth. In FIG. 4, steps 310, 312 and 314 are performed as described above. Likewise, step 320 is also performed. In step 410, after the sound level signals are generated, the sound level is minimized by moving the motor to move or adjust the windbreak. Minimizing the sound level may be performed in this example without the use of the calibrated windbreak position table. By minimizing the sound level, movement of the motor and the corresponding change in the sound is determined. The memory 46 in FIG. 2 may store the lowest sound level obtained so that the lowest sound level may be achieved at the desired position.

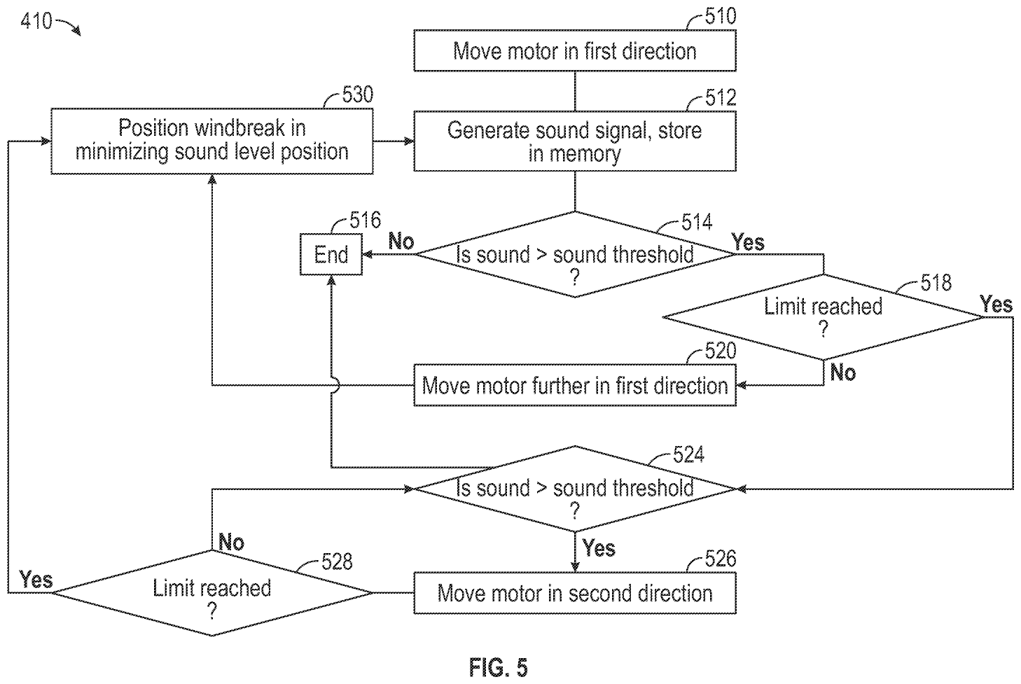

Referring now to FIG. 5, one method for minimizing the sound level by moving the windbreak is set forth. In step 510, the motor is moved in a first direction after steps 310-316. In step 512, the sound signal is generated, and the sound level which becomes a previous sound level is stored in the memory. In step 514, if the sound is not greater than a sound threshold, step 516 is performed which ends the process. In step 514, if the sound is greater than a sound threshold, step 518 determines whether a windbreak position limit has been reached. The position limit is either all the way up or down in this example. When the limit has not been reached, step 520 moves the windbreak in an incremental position in the first direction. After step 520, step 512 is again performed. In step 518, when the limit has been reached, step 524 determines whether the sound is greater than the sound threshold. When the sound is greater than the sound threshold, the motor moves the windbreak in a second direction. After step 526, step 528 determines whether a limit has been reached. If a limit has been reached, step 510 is performed. If the limit has not been reached in step 528, step 524 determines whether the sound is greater than the sound threshold and continues to move the motor in the second direction. In step 524, when the sound is not greater than a sound threshold, step 516 ends the process. At any time if a below the sound threshold sound level is not reached, step 530 may position the windbreak into a position with a minimum noise level in the interior of the interior of the vehicle based on the stored sound values.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for controlling a windbreak for a vehicle comprising:
determining a sound signal corresponding to a sound level within the vehicle; and
minimizing the sound level within the vehicle by moving the windbreak.

2. The method of claim 1 wherein determining the sound signal comprises determining the sound signal from a microphone.

3. The method of claim 1 wherein determining the sound signal comprises determining a sound signal from a plurality of microphones.

4. The method of claim 1 wherein moving the windbreak comprises changing a motor position of a motor coupled to the windbreak.

5. The method of claim 1 further comprising continually performing the steps of determining the sound signal and moving the windbreak.

6. The method of claim 1 further comprising storing a previous sound level in a memory and wherein minimizing the sound level comprises comparing the sound level to a sound threshold comprising the previous sound level.

7. The method of claim 1 further comprising determining a vehicle speed and performing the step of minimizing when the vehicle speed is below a vehicle speed threshold.

8. The method of claim 1 wherein moving the windbreak comprises moving the windbreak in a first direction and a second direction to minimize the sound level within the vehicle.

9. The method of claim 1 further comprising, prior to determining the sound signal, positioning the windbreak in an initial position relative to a vehicle speed or a panel position or both, and wherein minimizing the sound level comprises comparing the sound level to a calibrated position sound level.

10. The method of claim 1 further comprising, prior to determining the sound signal, positioning the windbreak in an initial position relative to a vehicle speed or a panel position or both, and wherein minimizing the sound level comprises comparing the sound level to a calibrated position sound level from a windbreak position table.

11. A system for controlling a windbreak for a vehicle comprising:
a sound sensor;
a controller programmed to determine a sound signal corresponding to a sound level within the vehicle; and
minimize the sound level within the vehicle by moving the windbreak.

12. The system of claim 11 wherein the controller is programmed to determine the sound signal by determining the sound signal from a microphone.

13. The system of claim 11 wherein the controller is programmed to determine the sound signal by determining a sound signal from a plurality of microphones.

14. The system of claim 11 wherein the controller is programmed to move the windbreak by changing a motor position of a motor coupled to the windbreak.

15. The system of claim 11 wherein the controller is programmed to continually determine the sound signal and move the windbreak.

16. The system of claim 11 wherein the controller is programmed to determine store a previous sound level in a memory and minimize the sound level by comparing the sound level to the previous sound level.

17. The system of claim 11 wherein the controller is programmed to determine a vehicle speed and minimize when the vehicle speed is below a vehicle speed threshold.

18. The system of claim 11 wherein the controller is programmed to move the windbreak by moving the windbreak in a first direction and a second direction to minimize the sound level within the vehicle.

19. The system of claim 11 herein the controller is programmed to position the windbreak in an initial position relative to a vehicle speed or a panel position or both, and the controller is programmed to minimize the sound level by comparing the sound level to a calibrated position sound level.

20. The system of claim 11 herein the controller is programmed to position the windbreak in an initial position relative to a vehicle speed or a panel position or both, and the controller is programmed to minimize the sound level by comparing the sound level to a calibrated position sound level.
from a windbreak position table.
